(19) United States
(12) Patent Application Publication
(10) Pub. No.: US 2014/0372290 A1
(43) Pub. Date: Dec. 18, 2014

(54) Face-to-Face Meeting Facilitation Systems, Methods and Computer-Program Products

(71) Applicants: Amin Khaef, Irvine, CA (US); Ramtin Khaef, Irvine, CA (US)

(72) Inventors: Amin Khaef, Irvine, CA (US); Ramtin Khaef, Irvine, CA (US)

(21) Appl. No.: 14/305,707

(22) Filed: Jun. 16, 2014

Related U.S. Application Data
(60) Provisional application No. 61/836,246, filed on Jun. 18, 2013.
(60) Provisional application No. 61/863,523, filed on Aug. 8, 2013.

(51) Int. Cl. H04L 29/06; G06Q 20/22

(52) U.S. Cl. CPC H04L 65/403; G06Q 20/223
USPC 705/39; 709/204

(57) ABSTRACT

Systems, methods and computer-program products are configured to facilitate the in-person (or “face-to-face”) meeting of online dating, social networking, and other Web site users. Such systems, methods, and computer-program products may allow for enhanced user experience (e.g., having their online dating site memberships translate to actual meetings of real people at a specific venue of mutual interest) and lead to more revenue generation opportunities for operators and advertising sponsors of such sites. The systems, methods and computer-program products may allow for the automated facilitation of a meeting among two or more members of an online site, while ensuring agreement by all parties on the details of the meeting itself, such as the venue, the party funding a purchase related to the meeting (e.g., a meal), and the purchase amount. Thus, the parties are ensured of having the face-to-face meeting and the venue is assured of patronage.

### CROSS REFERENCE TO RELATED APPLICATION

This application claims the benefit of U.S. Provisional Patent Application No. 61/836,246 (Atty. Docket No. 3046.01), filed Jun. 18, 2013, and claims the benefit of U.S. Provisional Patent Application No. 61/863,523 (Atty. Docket No. 3046.02), filed Aug. 8, 2013, the entire contents of both being hereby incorporated by reference in their entirety.

### FIELD OF THE DISCLOSURE

The present disclosure generally relates to social networking, online dating and other similar sites, and more particularly to systems, methods, and computer-program products for facilitating personal, “real-world” interaction among members of such sites.

### BACKGROUND

The statements in this section merely provide background information related to the present disclosure and may not constitute prior art.

In today's technological climate, there has been an explosion in the use of the global, public Internet. According to the International Telecommunication Union (ITU), in 2011, the world was home to 7 billion people, one third of which regularly use the Internet. On the Internet, many people use the World Wide Web to access news, weather and the like and use chat, messaging and email to make and stay in touch with friends and family members worldwide.

Increased usage of the Internet has coincided with the explosion in the use of mobile electronic devices around the world. Such “mobile devices” include, but are not limited to, personal digital assistants (PDAs), smartphones, mobile (cellular) telephones, tablet computers, notebook computers, laptops, portable media players, handheld game consoles, personal navigation devices, and like portable devices. Smartphones, however, make up a significant and quickly growing percentage of today's mobile devices. In fact, various studies show that smartphone penetration is over 25% in the United States, and over 14% worldwide, with the average smartphone user interacting with their device for more than two hours every day.

Given the explosion in Internet and mobile device usage (especially smartphones with Internet access), social networking websites have become more popular and created new ways to socialize and interact. Users of these sites are able to add a wide variety of information to their profile pages, to pursue common interests, and to connect with others. These sites have developed as a result of the Internet being used a major outlet for leisure activity since its inception. Given these technological and social developments, it is not surprising that online dating (or “Internet dating”) sites have developed that allow individuals to make contact and communicate with each other over the Internet, usually with the objective of developing personal, romantic or sexual relationships.

While some online dating sites provide free registration, many offer services which require a monthly or annual subscription fee. Other sites depend solely on advertising for their revenue or are free and then offer additional paid services in a “freemium” revenue model. Some sites are broad-based, with members coming from a variety of backgrounds looking for different types of relationships. Other sites are more specific, and based on the type of members (e.g., race, religion, ethnicity, sexual orientation, socio-economic status, etc.) or their interests, location, or type of relationship desired.

Online dating services generally require a prospective member to provide personal information, before they can search the service provider's database for other individuals using criteria they set, such as race, religion, age range, gender, physical characteristics, income, education, and location.

Online dating services usually provide un-moderated matchmaking over the Internet, through the use of personal computers or mobile devices. This can often lead to negative user experiences such as: fake profiles that are really advertisements; sites offering members to subscribe “blind,” meaning that users have little or no ability to search or preview the available profiles before they pay the subscription fee; paying members not knowing whether a potential contact has a paid subscription in order to reply to messages; and sites preventing potential contacts from even reading a paying member's messages unless they also subscribe. Many sites require both the sender and recipient of messages to be subscribers before any off-site communication or contact can be arranged and filter messages to remove email addresses, telephone numbers, web addresses, and surnames.

In the above-described environment, users often find it increasingly difficult to actually meet other users in person. Further, existing business models are focused on either making new “online friends” (i.e., social networking sites) or on simply providing a gallery of people to try to communicate with (i.e., dating sites). Again, this business model environment leaves the meeting of potential relationship partners in person to the users themselves. Additionally, when people eventually meet, they generally will choose venues such as restaurants, coffee shops, and bars, and these venues currently need a means of fulfilling that need in exchange for patronage (i.e., revenue).

Finally, the user-database businesses mentioned above (i.e., social networks and dating sites) have not yet found a way of monetizing from the service they provide—they either don't charge at all, simply earning advertising revenue, or charge a monthly fee that causes many users to feel buyers' remorse.

Given the foregoing, systems, methods, and computer-program products are needed that facilitate the in-person (or “face-to-face”) meeting of online dating, social networking, and other Web-site users. Such systems, methods, and computer-program products should allow for enhanced user experience (i.e., having their online dating site memberships translate to actual meetings of real people) and lead to more revenue generation opportunities for operators and advertising sponsors of such sites. That is, such systems, methods, and computer-program products should allow merchants to use the possibility of meeting new people at their venues as a sales and marketing channel.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the present disclosure meet the above-identified needs by providing systems, methods, and computer-program products for facilitating the in-person (i.e., real-world, face-to-face) meeting of social networking, online dating and other similar Web site users. Such systems, methods, and computer-program products should allow for enhanced user experience (i.e., having their online dating or other site memberships translate to actual meetings of real people at a specific venue of mutual interest) and lead to more revenue generation opportunities for operators and advertising sponsors of such sites.

In various aspects of the present disclosure, the method facilitates a face-to-face meeting between two users of an online site—an “initiator” who starts the process; and one or more “acknowledgers.” The initiator first creates an invitation by selecting a venue and experience for the potential meeting, selecting the purchaser of the experience (e.g., specifying that the initiator may pay, specifying that the acknowledger must pay, specifying that the initiator and the acknowledger will split the cost), the purchase amount, and one or more filters for acknowledgers eligible to accept the invitation. In such aspects, the invitation may be in the form of “$100 dinner-for-two coupon to Restaurant X for a single woman living in Los Angeles, Calif. aged from 25-35.” Then, after the invitation is created, one or more other users of the site who are eligible to accept—based on the filters specified by the initiator, may acknowledge the initiator's invite and thereby facilitate the in-person (i.e., “face-to-face”) meeting of the two online site users—the initiator and the chosen acknowledger.

In reality, most face-to-face meetings resulting from online interaction involve a hosting party (initiator) and guest party (acknowledger). Thus, in various aspects of the present disclosure, the hosting party has the advantage of differentiating himself/herself from other potential hosts by showing they are more serious than other members of the (online dating) site. Conversely, the guest party advantageously gains some level of safety that the host will not “stiff” them with the bill from the face-to-face meeting. Further, the guest party will have foreknowledge of the event and location where the face-to-face meeting will occur. This will increase anticipation of going to the meeting and reduce fears of going somewhere unsafe with an unknown person.

In various aspects of the present disclosure, the initiator may select a venue and experience for the potential meeting from among one or more advertisers who are direct sponsors of the (online dating) site. Such venue/experience combinations include, for example, dinner for two at a specific restaurant, two tickets to a specific sporting, theatrical, cinematic, entertainment or like event, two tickets for a vacation or admission for two to a theme park, ride, spa, festival, class, concert, charity event, any other event or the like. In such aspects, the online dating site and the merchant offering the experience would share in the revenue generated from the sale of the experience to the initiator or acknowledger.

In various aspects of the present disclosure, the initiator may select a venue and experience for the potential meeting from among one or more “deal-of-the-day” sites—such as Groupon.com (operated by Groupon, Inc. of Chicago, Ill.), LivingSocial.com (operated by LivingSocial Inc. of Washington, D.C.), PlumDistrict.com (operated by Plum District Inc. of San Francisco, Calif.), and the like—that have an affiliation with the operator of the social networking, online dating, or other membership-based site to which they belong. In such aspects, the operator of the online dating site, deal-of-the-day site and the merchant offering the experience would share in the revenue generated from the sale of the experience to the initiator or acknowledger.

In various aspects of the present disclosure, one or more third-party user(s) may suggest a venue and experience for the potential meeting. In such aspects, the operator of the online dating site and merchant offering the experience, and possibly the third-party user(s) would share in the revenue generated from the sale of the experience to the initiator or acknowledger.

In various aspects of the present disclosure, the site (e.g., an online dating site) may suggest a venue and experience for the potential meeting. In such aspects, the operator of the online dating site and merchant offering the experience would share in the revenue generated from the sale of the experience to the initiator or acknowledger.

In aspects of the present disclosure, the systems, methods, and computer-program products facilitate an in-person (i.e., real-world, face-to-face) meeting of social networking users, online dating users and users of other similar Web sites in a manner where there is agreement between the meeting parties about the venue, the members to be included, the activities planned (i.e., a reason for the meeting), the party funding any purchases associated with the meeting (e.g., meal, admission, etc.), the purchase amount, etc. Thus, the parties are ensured of having the face-to-face meeting and the merchant associated with the venue is assured of patronage.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of an exemplary system for facilitating the in-person (i.e., real-world, face-to-face) meeting of social networking, online dating and other similar Web site users, according to various aspects of the present disclosure.

FIG. 2 is a block diagram of an exemplary computing system useful for implementing the present disclosure.

FIG. 3 is a data flow diagram of an exemplary network system facilitating in-person meetings between users of a social network, such as a dating website, according to various aspects of the present disclosure.

FIG. 4 is a flowchart illustrating an exemplary process for facilitating in-person meetings between users of a social network, more specifically, the initial coordination between an initiator and at least one acknowledger, according to an aspect of the present disclosure.

FIG. 5 is a flowchart illustrating an exemplary process for facilitating in-person meetings between users of a social network, more specifically, the negotiation between an initiator and at least one acknowledger, according to an aspect of the present disclosure.

FIG. 6 is a flowchart illustrating an exemplary process for facilitating in-person meetings between users of a social network, more specifically, the coordination between vendors and event initiation requests, according to an aspect of the present disclosure.

FIG. 7 is a flowchart illustrating an exemplary process for facilitating in-person meetings between users of a social network, more specifically, the payment processing for in-person meetings between an initiator and at least one acknowledger, according to an aspect of the present disclosure.

### DETAILED DESCRIPTION

The present disclosure is directed to systems, methods, and computer-program products for facilitating an in-person (“face-to-face”) meeting of online dating, social networking, and other Web site users. Such systems, methods, and computer-program products allow for enhanced user experience (e.g., having their online dating site memberships translate to actual meetings of real people at a specific venue of mutual interest) and lead to more revenue generation opportunities for operators and advertising sponsors of such sites.

Aspects of the present disclosure provide systems, methods, and computer-program products that can be used in any context where a face-to-face meeting between two (or more) users of an online site is beneficial. In such aspects, there is one member deemed an “initiator” (or first user) who starts the process by submitting an event initiation request; and one or more members who are deemed “acknowledgers” (or second user(s)), who may act in response to event initiation requests. A user may be one or both of an initiator and an acknowledger. For example, a user may act as an initiator in some instances by submitting the event initiation request and, at other times, may act as an acknowledger by responding to an event initiation request from another user.

In some aspects, the present disclosure provides systems, methods and computer-program products for facilitating meetings among parties, in which the details of the meeting are suggested by the online dating site. For example, during a chat between an initiator and an acknowledger, the site may recommend specials and sponsors or display local ads based on each user's prior ratings, both users' prior common or similar ratings, each user's location, locations convenient for both users, each user's interests, both users' common or similar interests, or the like. The users may then be given the option to rate site suggestions in an effort to determine a mutually desirable venue. In another example, during a chat between an initiator and an acknowledger, the site may suggest the offer for sale of a pre-approved gift certificate. The initiator may then purchase the gift certificate and provide the acknowledger with confirmation. In yet another example, during a chat between two users, the site may suggest a venue or offer for sale a pre-approved gift certificate for a venue located between the user's respective locations.

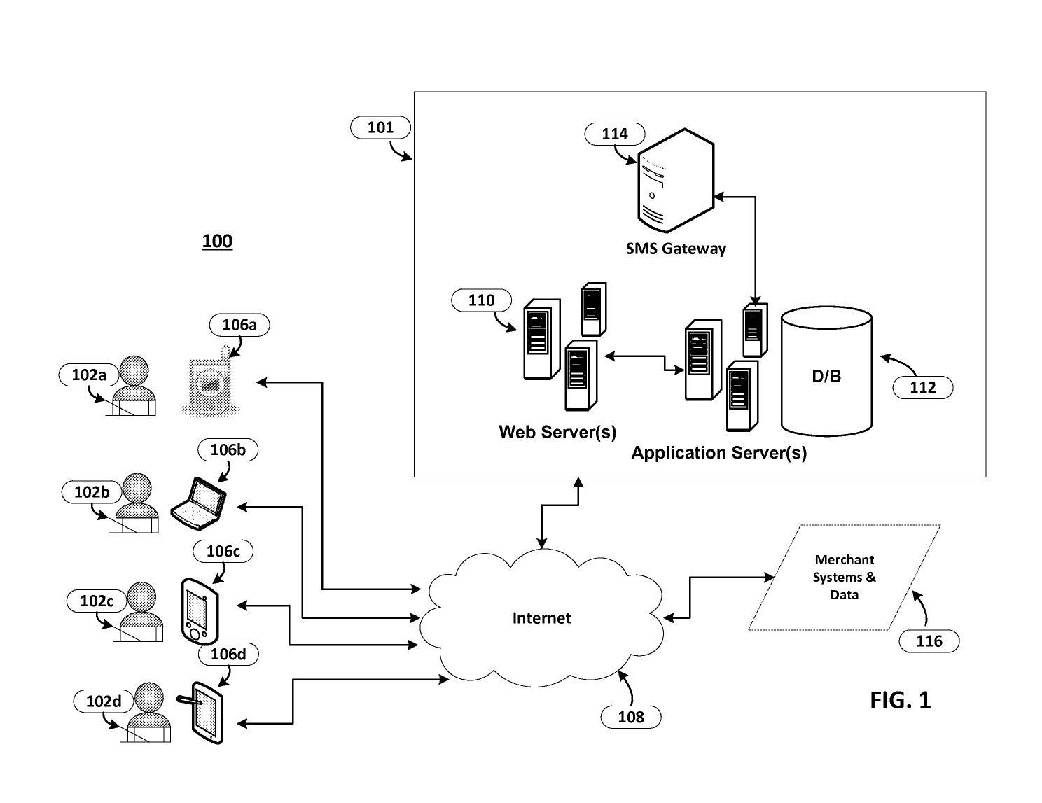

Referring now to FIG. 1, a block diagram of an exemplary system 100 for facilitating the in-person meeting of social networking, online dating and other similar Web site users, according to various aspects of the present disclosure, is shown.

Cloud-based, Internet-enabled device communication system 100 includes a plurality of users 102 (shown as users 102a-d in FIG. 1) accessing—via a computing device 106 (shown as respective mobile devices 106a-d in FIG. 1) and a network 108, such as the global, public Internet—an application service provider's cloud-based, Internet-enabled infrastructure 101. User 102 may access infrastructure 101 in order to facilitate interactions with other user/members of a social networking, online dating or other similar Web site as “initiators” or “acknowledgers.” In various aspects, computing device 106 may be configured as: a mobile telephone 106a; a laptop computer 106b; a Personal Digital Assistant (PDA) or smartphone 106c; a notebook, tablet or mobile computer 106d; a desktop, a PC or any commercially-available intelligent communications device; or the like.

As shown in FIG. 1, in some aspects of the present disclosure, an application service provider's infrastructure 101 may include (but is not limited to) one or more web servers 110, one or more application servers 112, one or more SMS gateways 114, and one or more merchant system and data feeds 116.

As will be appreciated by those skilled in the relevant art(s) after reading the description herein, in such an aspect, an application service provider—an individual person, business, or other entity—may allow access, on a free registration, paid subscriber and/or pay-per-use basis, to infrastructure 101 via one or more World-Wide Web (WWW) sites on Internet 108. Thus, system 100 is scalable.

As will also be appreciated by those skilled in the relevant art(s), in an aspect, various screens would be generated by web server 110 in response to input from users 102 over Internet 108. That is, in such an aspect, server 110 is a typical web server running a server application at a website which sends out webpages, while in communications with application server 112, in response to Hypertext Transfer Protocol (HTTP) or Hypertext Transfer Protocol Secured (HTTPS) requests from remote browsers on various computing devices 106 being used by various users 102. Thus, server 110 is able to provide a graphical user interface (GUI) to users 102 of system 100 in the form of webpages. These webpages are sent to the user's mobile or like computing device 106, and would result in the GUI being displayed.

In some aspects, application servers 112 (shown with associated storage in FIG. 1) may be configured to store various modules and data associated with various merchants, experience venue locations, user 102 registration and demographic information, payment information, merchant information, management information, invitation data, and the like. In some aspects, application servers 112 may comprise one or more data stores within (or remotely located from) infrastructure 101 or be a memory included in (or coupled to) web server(s) 110. That is, in some aspects, web servers 110 and application servers 112 may be located on the same physical machines as will be appreciated by those skilled in the relevant art(s) after reading the description herein. In some aspects, application servers 112 may send text messages or other notifications (e.g., invitations reminders, message notifications, GPS-enabled, location-based coupon authentications, etc.) to users 102 who are “offline” via SMS gateway 114.

As will be appreciated by those skilled in the relevant art(s) after reading the description herein, various aspects of the present disclosure may include providing a tool for facilitating face-to-face meetings between members of social networking, online dating and other similar Web site as a stand-alone system (e.g., installed on one server PC) or as an enterprise system wherein all the components of infrastructure 101 are connected and communicate via an inter-corporate Wide Area Network (WAN) or Local Area Network (LAN). For example, in aspects where users 102 are all customers of the same merchant company (or affiliated companies), the present disclosure may be implemented as a stand-alone system, rather than as a web service (e.g., Application Service Provider (ASP) model utilized by various unassociated/unaffiliated users and merchants) as shown in FIG. 1.

As will also be appreciated by those skilled in the relevant art(s) after reading the description herein, various aspects of the present disclosure may include providing the tools for facilitating the in-person (i.e., real-world, face-to-face) meeting of social networking, online dating and other similar Web site users via an installed application, a browser pre-installed with an applet or a browser with a separately downloaded applet on communication devices 106. That is, as will also be apparent to one skilled in the relevant art(s) after reading the description herein, an applet that facilitates the solution of the present disclosure disclosed herein may be part of the “standard” browser that ships with computing device 106 or may be later added to an existing browser as part of an “add-on,” or “plug-in,” or may be added as a separate mobile application software (app) capable of executing on computing device 106 after an “app store download.”

In some aspects, system 100 and its accompanying methods and computer-program products of the present disclosure is configured to facilitate the in-person (i.e., real-world, face-to-face) meeting amongst members of an online dating site. Thus, the present disclosure is now described in more detail herein in terms of the above exemplary context. This is for convenience only and is not intended to limit the application of the present disclosure. In fact, after reading the following description, it will be apparent to one skilled in the relevant art(s) how to implement the following disclosure in alternative embodiments (e.g., any context where facilitating the in-person meetings among members of an online site would be beneficial).

The terms “initiator,” “acknowledger,” “party,” “user,” “consumer”, “customer,” “member,” and/or the plural form of these terms are used interchangeably throughout herein to refer to those persons capable of accessing, using, be affected by and/or benefiting from the tool that the present disclosure provides for facilitating the in-person (or “face-to-face”) meeting of online dating, social networking and other Web site users.

Furthermore, the terms “business” or “merchant” or “vendor” may be used interchangeably with each other and shall mean any person, entity, distributor system, software and/or hardware that is a provider, broker and/or any other entity in the distribution chain of goods or services. For example, a merchant may be a movie theater, a public transportation agency, a grocery store, a retail store, a travel agency, a service provider, a concert promoter, an on-line merchant or the like.

Now, herein described is a method for facilitating the in-person (“face-to-face”) meeting between online dating site users (e.g., between an initiator “initiator” and an acknowledger “acknowledger”), according to various aspects of the present disclosure: As will be appreciated by those skilled in the relevant art(s) after reading the description herein, the above method for facilitating the in-person (“face-to-face”) meeting between online dating site users may be implemented in ways other than that described above. For example, in some aspects, the list of available invitations (i.e., venue and amount purchase options) may be served to infrastructure 101 via data feed 116 directly from merchant relationships with the online dating site operator or indirectly from “deal-of-the-day” website operators (who may then also share in the proceeds along with the venue, merchant and the online dating site operator).

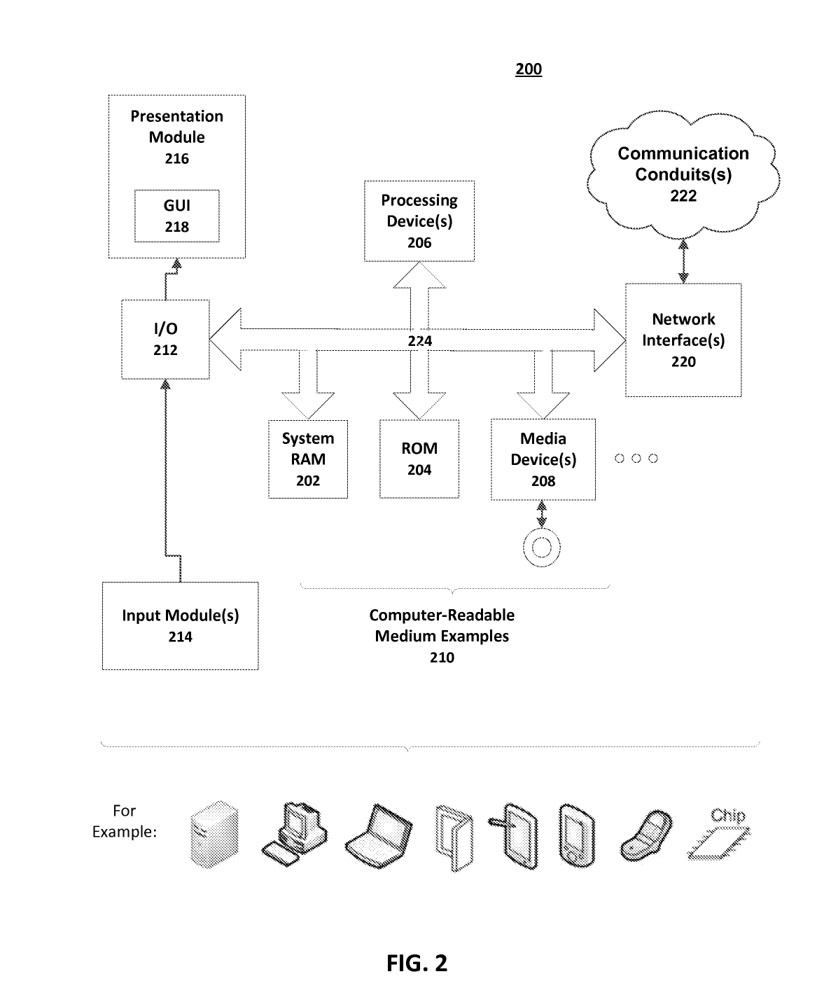

Referring now to FIG. 2, a block diagram of an exemplary computer system useful for implementing various aspects the processes disclosed herein, in accordance with one or more aspects of the present disclosure, is shown. That is, FIG. 2 sets forth illustrative computing functionality 200 that may be used to implement one or more components of system 100, such as (but not limited to) web server 110, one or more application servers 112, computing devices 106 utilized by users 102 to access Internet 108, or any other component of system 100. In all cases, computing functionality 200 represents one or more physical and tangible processing mechanisms.

Computing functionality 200 may comprise volatile and non-volatile memory, such as RAM 202 and ROM 204, as well as one or more processing devices 206 (e.g., one or more central processing units (CPUs), one or more graphical processing units (GPUs), and the like). Computing functionality 200 also optionally comprises various media devices 208, such as a hard disk module, an optical disk module, and so forth. Computing functionality 200 may perform various operations identified above when the processing device(s) 206 executes instructions that are maintained by memory (e.g., RAM 202, ROM 204, and the like).

More generally, instructions and other information may be stored on any computer readable medium 210, including, but not limited to, static memory storage devices, magnetic storage devices, and optical storage devices. The term “computer readable medium” also encompasses plural storage devices. In all cases, computer readable medium 210 represents some form of physical and tangible entity. By way of example, and not limitation, computer readable medium 210 may comprise “computer storage media” and “communications media.”

“Computer storage media” comprises volatile and non-volatile, removable and non-removable media implemented in any method or technology for storage of information, such as computer readable instructions, data structures, program modules or other data. Computer storage media may be, for example, and not limitation, RAM 202, ROM 204, EEPROM, Flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 200 may also comprise an input/output module 212 for receiving various inputs (via input modules 214), and for providing various outputs (via one or more output modules). One particular output mechanism may be a presentation module 216 and an associated GUI 218. Computing functionality 200 may also include one or more network interfaces 220 for exchanging data with other devices via one or more communication conduits 222. In some aspects, one or more communication buses 224 communicatively couple the above-described components together.

Communication conduit(s) 222 may be implemented in any manner (e.g., by a local area network, a wide area network (e.g., the Internet), and the like, or any combination thereof). Communication conduit(s) 222 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The terms “service,” “module” and “component” as used herein generally represent software, firmware, hardware or combinations thereof. In the case of a software implementation, the service, module or component represents program code that performs specified tasks when executed on one or more processors. The program code may be stored in one or more computer readable memory devices, as described with reference to FIG. 2. The features of the present disclosure described herein are platform-independent, meaning that the techniques can be implemented on a variety of commercial computing platforms having a variety of processors (e.g., desktop, laptop, notebook, tablet computer, personal digital assistant (PDA), mobile telephone, smart telephone, gaming console and the like).

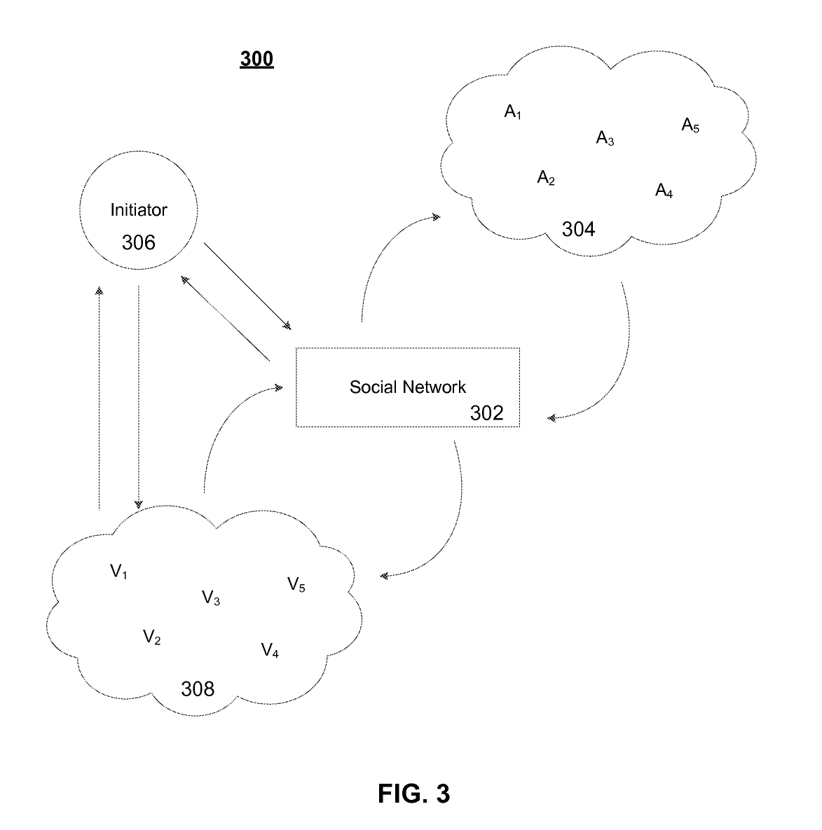

Referring now to FIG. 3, a data flow diagram of a network system 200, which may execute within the system 100 illustrated in FIG. 1, facilitating face-to-face meetings between an initiator and an acknowledger is illustrated. For illustrative purposes, the centralized social networking system 101 is shown as a dating site 302, which may comprise a pool of acknowledgers 304. In some aspects, the initiator 306 may also be part of the pool of acknowledgers 304, when another individual is acting as an initiator.

The initiator 306 may submit an event initiation request to the dating site 302, which may then assess profile attributes that may be linked to the event. For example, an event initiation request for rock climbing may be associated with profile attributes such as “outdoorsy” or “adventurous.” The dating site 302 may access the pool of potential acknowledgers 304 and select one or more of the most compatible acknowledgers to connect with the initiator 306. Connections between the initiator 306 and the acknowledger may occur online, such as through email or an online chat room, or over the phone. The method of connection may depend on the dating site and/or the preferences of the initiator and acknowledger.

In some aspects, the initiator 306 may be able to directly interface with a pool of vendors 308, wherein the initiator 306 may browse or search for the most appealing events. In other aspects, the initiator 306 may submit the event initiation request, and the dating site 302 may access the pool of vendors 308 based on the request. In some aspects, the dating site 302 may be interest based, and specific vendors may offer special deals geared toward that interest, wherein the dating site 302 may allow the initiator 306 to select from the offers from the pool of vendors 308.

In still further aspects, the website may provide multiple methods of event selection. For example, the pool of vendors 308 may offer special deals for a handful of events, but if the initiator 306 submits an event initiation other than those deals, the website 302 may access the pool of vendors 308 to provide more compatible event choices to the initiator 306.

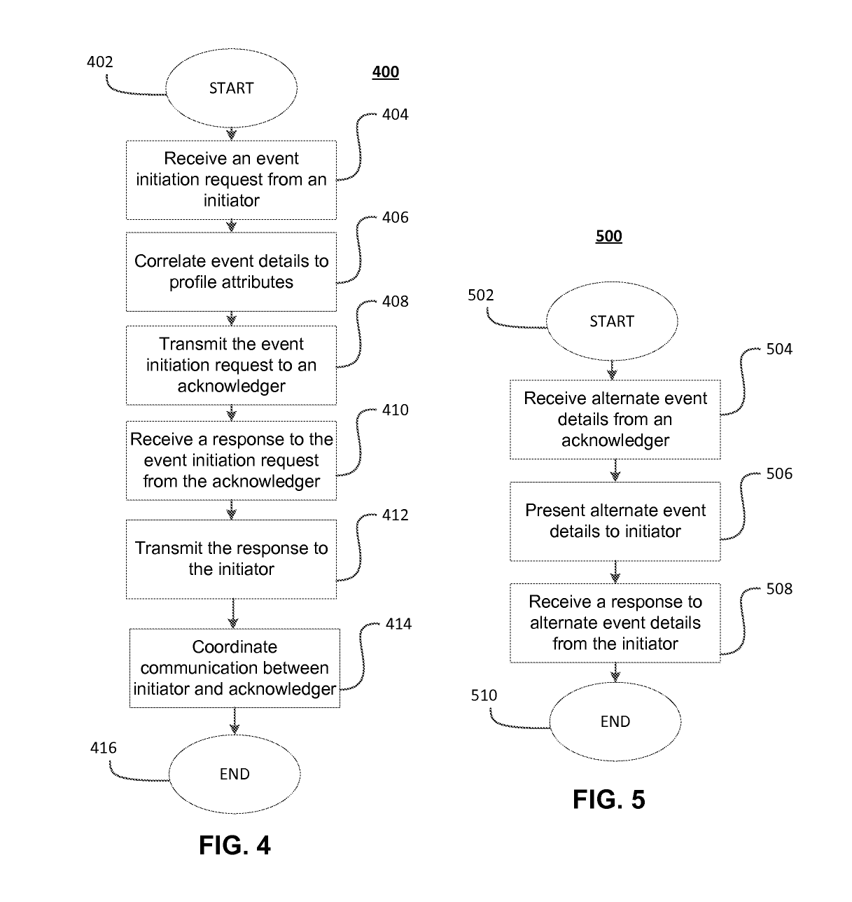

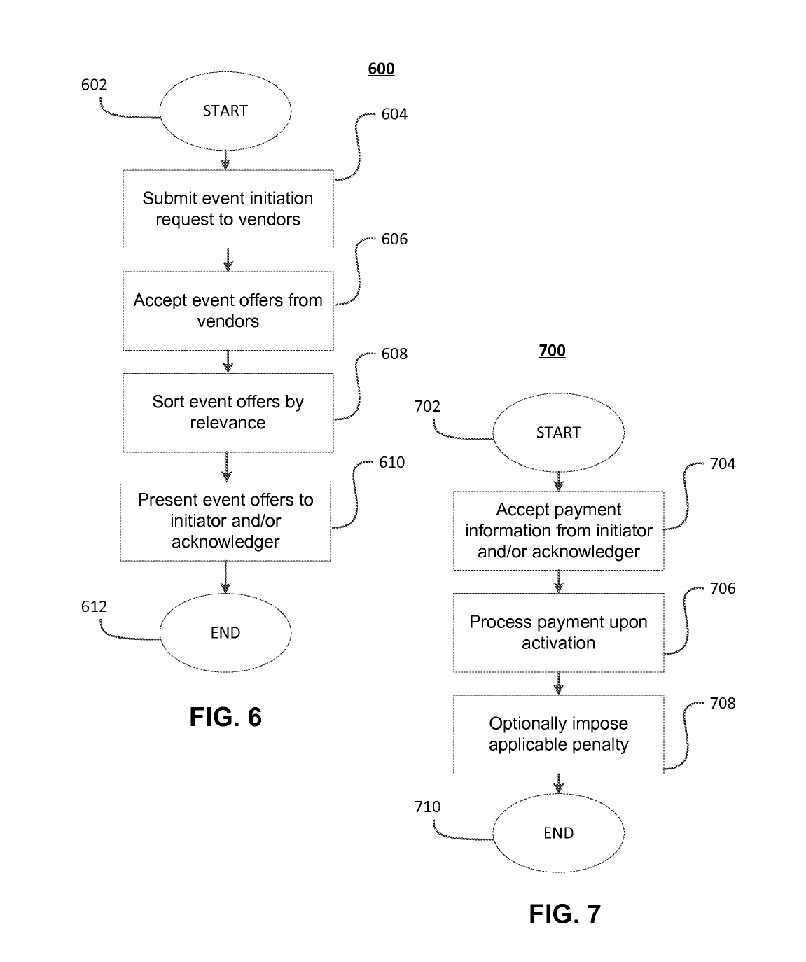

FIG. 4 is a flowchart illustrating an exemplary process 400 for facilitating in-person meetings between users 102 of a social network, more specifically, the initial coordination between an initiator and at least one acknowledger, according to an aspect of the present disclosure.

Process 400, which may execute within system 100, begins at step 402 with control passing immediately to step 404.

At step 404, infrastructure 101 receives an event initiation request from an initiator. The initiator first creates an event initiation request by selecting a venue and experience for the potential meeting, selecting the purchaser of the experience (e.g., the initiator may pay or specify that the acknowledger must pay), the purchase amount, and one or more filters for acknowledgers eligible to accept the invitation. In such aspects, the invitation may be in the form of “$100 dinner-for-two coupon to Restaurant X for a single woman living in the Los Angeles, Calif. area, aged from 25-35.” Then, after the invitation is created, one or more other users 102 of the site who are eligible to accept—based on the filters specified by the initiator, may acknowledge the initiator's invite and thereby facilitate the in-person (i.e., “face-to-face”) meeting of the two online site users—the initiator and the chosen acknowledger.

In some aspects, the present disclosure provides systems, methods and computer-program products for facilitating meetings among parties, in which details of the meeting are distributed among members of an online dating site. For example, an initiator may post to their profile an indicator such as: “I'm hosting a meeting for two at XYZ restaurant. Once [description of desired date] accepts, I'll be purchasing a $150 voucher there.” In another example, the meeting initiator may post to their profile an indicator such as: “I'd like to go to XYZ restaurant for a $100 meal. Can [description of desired date] take me and pay?” In yet another example, the meeting initiator may only specify on their profile that they are willing to “take [description of desired date] somewhere for $200,” without specifying a venue. This allows an acknowledger to propose a specific venue. In these three examples, a specific acknowledger was not specified, but only “filters” as to who should propose to accept the invitation.

At step 406, infrastructure 101 correlates event details to profile attributes, wherein the profile attributes of potential acknowledgers may be extracted from the profile information and external sources.

As will be appreciated by those skilled in the relevant art(s) after reading the description herein, in various aspects of the present disclosure, the users may choose to provide photographs on their respective profiles to describe themselves. In such aspects, the users may choose from a database of interchangeable photographs and phrases that represent personality traits and interests. The users may choose from among levels (e.g., from levels 1 to 5 where “very outgoing” is a level 5) assigned to each personality trait to describe themselves. Each level may contain corresponding photographs and phrases. For example, if a user (e.g. initiator) is often tardy, initiator may elect to post a photograph on his/her profile with the phrase “Punctuality is not my finer trait.”

As will be appreciated by those skilled in the relevant art(s) after reading the description herein, in various aspects of the present disclosure, the site may employ a test to determine the personality type of each user. The site may then provision advertisements for potential meeting venues/events based on such personality profiles. In an alternate aspect, the site may suggest profiles based on characteristics of previous selections (e.g., characteristics of previously-matched users, previously-purchased experiences, etc.).

As will also be appreciated by those skilled in the relevant art(s) after reading the description herein, in some aspects of the present disclosure, the online dating site may enforce the filters specified by the initiator/initiator (using previously-stored demographic data collected and stored during the registration process) or simply allow acknowledgers to “self-police” themselves before attempting to acknowledge invitations.

At step 408, infrastructure 101 transmits the event initiation request to at least one acknowledger or pool of potential acknowledgers, such as described and illustrated in FIG. 3.

In one aspect, when a user registers to become a member of the site, the user may rate the venues and such ratings may be specified on their profile. Such aspects are is beneficial to members of the site to facilitate actual, in-person meetings, as well as being beneficial to business venues, such as restaurants, to have a means of attracting patronage (especially those in the form of prepaid sales).

In some aspects, the present disclosure provides systems, methods and computer-program products for facilitating meetings among parties, in which details of the meeting are distributed among members of an online dating site. For example, a recruiter/initiator on a business (e.g., LinkedIn®) networking site can make a dinner offer eligible to anyone who is a “Flash Memory Design Manager,” or any other person with some desired skill(s) they seek to place at one of their client's open job positions.

In some aspects, the present disclosure provides systems, methods and computer-program products for facilitating meetings among parties, in which the details of the meeting are distributed among members of an online dating site. For example, an initiator may choose to pre-purchase gift certificates or pre-authorize a date to one or more selected venues. Once the purchase is made, a confirmation receipt may be shown on the initiator's profile. An initiator may post to their profile an indicator such as: “I'd like to use one of the certificates on my profile. I am willing to take [description of desired date] who may choose from the available gift certificates.” The online dating site may track the status of the gift certificates (available versus unavailable). In an alternate aspect, the initiator's profile may list sponsored venue favorites from which the acknowledger may choose.

In yet another aspect, when an acknowledger searches for a type of meeting or venue using keywords, the site may suggest an initiator's offer that matches the acknowledger's keyword search. In either aspect, the initiator may request that the acknowledger purchase the gift certificate for the meeting.

In yet another aspect, an acknowledger can request to be paired with somebody nearby without a specific search, and the site may suggest to be paired with a nearby initiator, along with details of a selected offer. The initiator may have specified who is to be the purchaser, or may have left that detail to-be-determined. The acknowledger may have specified on the request to pair that the acknowledger would only like to be paired with someone matching a specific purchase criteria (such as who is paying, price, etc.).

In some aspects, the present disclosure provides systems, methods and computer-program products for facilitating meetings among parties, in which the details of the meeting are distributed among members of an online dating site. A sponsor may offer the (online dating) site a discount or special offer for users that pre-purchase gift certificates. An initiator may post the discount or special offer to their profile and invite others users to join. For example, an initiator may post to their profile an indicator such as “I would like to go to XYZ venue today. The venue is offering 20% off of all prepaid reservations. Who would like to split the reservation at $40 each and join the group?” The offer may include a minimum number of acknowledgers or minimum dollar amount. One or more acknowledgers may propose to pre-purchase gift certificates to join the meeting. The initiator may then choose from the acknowledgers and close the offer. The group may then pre-reserve the meeting with the pre-purchased gift certificates at the specified dollar amounts.

In some aspects, a user (e.g. initiator) may specify interest in another user (e.g., acknowledger) and the (online dating) site may provide acknowledger's favorite venues, with the site's sponsored venues appearing first. Initiator may create the invitation specifically for acknowledger by including one of acknowledger's favorite venues in the invitation. Upon creation of the invitation, system 100 may provide the invitation to the other user and notify such user of the invitation.

As will be appreciated by those skilled in the relevant art(s) after reading the description herein, in various aspects of the present disclosure, multiple users may qualify to accept the initiator invitation and thus initiator may choose from multiple offers to acknowledge their invitation. In such aspects, the online dating site may allow “acknowledgers” (i.e., those members seeking to acknowledge invitations from a “initiator” initiator) to freely browse profiles looking for invitations to acknowledge, may employ a match algorithm (e.g., the Myers-Briggs personality test) to suggest invitations to acknowledge, or may allow searching specifically based on characteristics of previously-purchased invitations (e.g., searching by venue, date, merchant, type of experience, etc.).

At step 410, infrastructure 101 receives a response to the event initiation request from at least one acknowledger.

At step 412, infrastructure 101 transmits the response to the initiator.

At step 414, infrastructure 101 coordinates communication between initiator and at least one acknowledger.

In some aspects, the present disclosure provides systems, methods and computer-program products for facilitating group dating, in which the details of a meeting between a group or groups of users are distributed among members of an online dating site. For example, an initiator may make a group event offer eligible to other users based on specified filters (e.g. interests, type of venue desired, etc.). In such aspects, the offer may state: “I am interested in going to XYZ venue tonight because XYZ is offering electronic music. Who is interested in joining?” One or more acknowledgers may express interest in attending the event. The acknowledgers may form one or more groups or invite other users and non-users to attend the event.

In some aspects, a user may attend a group event. Each attendee may be given the option to rate the experience with each other attendee. Attendees may or may not be members of the online dating site. If an attendee is a member of the online dating site, that attendee may choose to make the ratings public or private. If the attendee chooses to make the rating(s) public, the rating(s) may appear on the attendee's profile. If an attendee is not a member of the online dating site, a rating notice and invitation to join the online dating site may be sent to the attendee through social media (e.g., Facebook), email or the like.

In some aspects, a user may vouch for another user to increase the second user's perceived credibility or safety on the site. A user can also vouch for a user that's not a yet member of the site, and have the vouch be ready for the non-member once they join. Additionally, if the person receiving the vouch is not a member of the site, a notice of the vouch and an invitation to join the site may be sent to the person receiving the vouch through social media (e.g., Facebook), email or the like.

A member of the site can also request another person to vouch for them. If this request is made to a non-member of the site, the request along with an invitation to join the site may be sent to the non-member through social media (e.g., Facebook), email or the like.

Process 400 then terminates at step 416.

FIG. 5 is a flowchart illustrating an exemplary process 500 for facilitating in-person meetings between users of a social network, more specifically, the negotiation between an initiator and at least one acknowledger, according to an aspect of the present disclosure. Process 500 may generally occur after Process 400.

Process 500, which may execute within system 100, begins at step 502 with control passing immediately to step 504.

At step 504, infrastructure 101 receives alternate event details from an acknowledger. In some aspects, initiator may suggest a venue that is declined by acknowledger for a specified reason.

At step 506, infrastructure 101 presents alternate even details to initiator acknowledger may then present options to initiator based upon new criteria. For example, acknowledger may decline the original invitation because the location is too far, the type of food is undesirable, or another venue is preferred. Acknowledger would then suggest a venue, thus facilitating a negotiation process.

At step 508, infrastructure 101 receives a response to the alternate event details from the initiator. In some aspects, the purchased invitation (i.e., the venue/experience combination) may be flexible in that it may allow acknowledger to choose between two or more options (e.g., “$100 dinner coupon at Restaurant X or Y”).

Process 500 then terminates at step 510.

FIG. 600 is a flowchart illustrating an exemplary process 600 for facilitating in-person meetings between users of a social network, more specifically, the coordination between vendors and event initiation requests, according to an aspect of the present disclosure. Process 600 may not be limited to a particular order in relation to Process 400.

Process 600, which may execute within system 100, begins at step 602 with control passing immediately to step 604.

At step 604, infrastructure 101 submits event initiation request to a vendor or pool of vendors, such as described in FIG. 3.

At step 606, infrastructure 101 accepts event offers from a vendor or pool of vendors, such as described in FIG. 3.

In some aspects, the present disclosure provides systems, methods and computer-program products for facilitating meetings among parties, in which the details of the meeting are suggested by the online dating site after a number of (email) messages have been exchanged between the parties. For example, the site may suggest the offer for sale of a gift certificate for a particular date, offer or venue. The suggestions may include sponsored favorites of the users. The initiator may then purchase the gift certificate and provide the acknowledger with confirmation.

In an aspect, system 100 would offer users 102 who want to be initiators one or more experience/venue options to be used as the basis for invitations. Such options would be available within infrastructure 101 via merchant system and data feed 116. In alternate aspects, the initiator may select a venue and experience for a potential meeting from among one or more advertisers who are direct sponsors of the online dating site, or from among one or more “deal-of-the-day” sites that have an affiliation with the operator of the online dating site.

In such aspects, the venue/experience may be, for example, dinner for two at a specific restaurant, two tickets to a specific sporting, theatrical, cinematic, entertainment event, two tickets for a vacation, admission for two to a theme park, ride, spa, festival, class, concert, charity event, any other event or the like. In such aspects, the online dating site, deal-of-the-day site and/or the merchant offering the experience would share in the revenue generated from the sale of the experience to the initiator or acknowledger.

At step 608, infrastructure 101 sorts event offers by relevance. In some aspects, relevance may be determined by prior event initiation requests and/or responses to event initiation requests. In still further aspects, relevance may be determined by profile attributes input by users. In some aspects, event offers may be sorted based on the event initiation request, wherein event offers that most closely match the event details of the event initiation request are presented first.

At step 610, infrastructure 101 presents event offers to initiator and/or acknowledger or pool of acknowledgers. In some aspects, event offers may be presented prior to the receipt of an event initiation request, wherein event offers may entice a user to become an initiator and submit the event initiation request.

Process 600 then terminates at step 612.

FIG. 7 is a flowchart illustrating an exemplary process 700 for facilitating in-person meetings between users of a social network, more specifically, the payment processing for in-person meetings between an initiator and at least one acknowledger, according to an aspect of the present disclosure.

Process 700, which may execute within system 100, begins at step 702 with control passing immediately to step 704.

At step 704, infrastructure 101 accepts payment information from the designated purchaser, which may be one or both the initiator and the acknowledger. In some aspects, acknowledger may be required to pay a small fee to accept (i.e., acknowledge) the invitation from Initiator. In such aspects, due to having to outlay a sum of money, initiator is more assured that acknowledger will actually attend the confirmed meeting.

In some aspects, initiator may be required to pay a small fee (in addition to the invitation amount) to initiate the invitation other users (e.g., acknowledger). In particular aspects, the fee may be returned (or credited to the invitation amount) if acknowledger accepts (acknowledges) the invitation from initiator. In some aspects, initiator may not actually be charged for the invitation—despite their payment (e.g., credit card, debit card, gift card, checking, PayPal® account, Google® Wallet account, or the like) account information being collected, until acknowledger accepts the invitation and acknowledger confirms the meeting.

In some aspects, initiator may specify in the invitation that acknowledger is the paying party and thus, in the example described above, infrastructure 101 would receive the $100 payment from acknowledger, either by receiving current payment information or using payment information previously stored (e.g., during the online dating site registration process) after initiator confirms the meeting.

In some aspects, initiator or acknowledger may be given a credit (e.g. OR® code, prepaid card, credit to the site for a future event or credit towards a gift for the meeting) to be redeemed at a later date. For example, the purchaser may issue a $100 payment to the site and in turn, the site will issue the purchaser a OR® code for the venue of their choice at a later chosen date. In some aspects, initiator may be issued a paper or electronic coupon as evidence of their purchase of the invitation (e.g., the $100 dinner-for-two coupon to venue A). Then, the online dating site may employ location-based services to ensure that coupon is activated (i.e., useable) only when initiator is in close proximity to acknowledger and/or the venue (e.g., when both initiator and acknowledger arrive at venue A as verified by an application executing on their respective mobile telephones, which identifying information was collected by infrastructure 101 at the time of initiator and acknowledger becoming members of the online dating site or later). In some aspects, the site may employ services to ensure that the coupon is activated only when initiator is in close proximity to one or more of acknowledger and the venue and at a designated time of the date (e.g., around 7:00 p.m.).

In some aspects, one of the users (e.g., initiator) pays for the invitation amount completely. In other aspects, one or more parties collectively pay for the invitation amount. For example, initiator may pay for 70% of the invitation amount and acknowledger may pay for 30% of the invitation amount. In particular aspects, the percentage breakdown may be provided in the invitation, for example. As another example, initiator may pay a first portion (e.g., 60%) of the invitation amount and a third party (e.g., the online dating site, the venue, an advertiser, etc.) may pay a second portion (e.g., 40%) of the invitation amount.

In some aspects of the present disclosure, initiator or acknowledger—whoever is the purchaser—may elect to donate a portion of the payment to one or more charities. The portion of payment going to charity may be donated by the member, venue and/or site operator, as determined by the parties.

At step 706, infrastructure 101 processes payment of the event upon activation. In various aspects, the system of the present disclosure may use location-based services, for example via a GPS-enabled mobile device, to ensure that the purchased experience coupon (e.g., $100 dinner-for-two coupon to Restaurant X) is activated only when the purchaser/initiator is in close proximity to both the specific acknowledger who accepted the invitation online and the venue (e.g., when both the initiator and the acknowledger arrive at Restaurant X as verified by an application executing on their respective mobile telephones).

In some aspects, the online dating site may employ location based services to indicate when initiator and acknowledger are together at a venue for safety reasons. The location based services may include applications executing on their respective mobile telephones which includes event-based safety codes that may be initiated by initiator or acknowledger (e.g., signifying arriving at the venue, safe at the venue, departing the venue, etc.). In such aspects, initiator or acknowledger may give notice of a meeting to pre-selected friends. Then, if initiator or acknowledger does not give the “I'm okay” to the pre-selected friends, the friends are informed that initiator or acknowledger may be in danger. The location based services may issue initiator or acknowledger's current location to the pre-selected friends

In some aspects, the online dating site may employ location-based services to indicate when users are within close proximity to other users. This may provide a user (e.g. initiator) the opportunity to present a meeting offer, drink offer, offer to join tables, or the like to another user (e.g. acknowledger) or users who are within a pre-determined proximity range. If both parties agree, they are notified of the match, and if the offer involved a purchase, a transaction occurs.

At step 708, infrastructure 101 optionally imposes a penalty, when appropriate, based on the terms of the event. In some aspects of the present disclosure, if either initiator or acknowledger fails to attend, or arrives late to, the scheduled meeting, the online dating site may impose a penalty on the offending party. Such penalties may include, for example, allowing the non-offending part to post negative feedback on the offending party's profile and/or imposing a “no-show” fee.” or “late fee.” Further, the purchasing party may be afforded a full or partial refund for purchase of the invitation. In the alternative, initiator and acknowledger may pre-determine the meeting details such as venue, purchaser, date and time. The online dating site may employ location-based services to ensure that initiator and acknowledger appear at the venue at the pre-determined date/time. If both parties attend, or if the pre-determined purchaser fails to attend and the other party appears, the pre-determined purchaser may be charged the purchase amount of the invitation.

Process 700 then terminates at step 710.

While various aspects of the present disclosure have been on described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein). As will be appreciated by those skilled in the relevant art(s) after reading the description herein, certain features from different aspects of the systems, methods and computer-program products of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A computer-implemented method for facilitating a personal, face-to-face meeting between a plurality of users, wherein the plurality of users comprises at least an initiator and a first acknowledger, the method comprising the steps of:
(a) receiving, at a communications server, an event initiation request from the initiator,
(b) transmitting, via a network, the event initiation request to the first acknowledger;
(c) receiving, at the communications server, at least one response to the event initiation request from the first acknowledger;
(d) transmitting, via the network, the at least one response to the initiator;
(e) coordinating, over the network, at least one event detail related to the event initiation request; and
(f) coordinating, over the network, communication between the initiator and the first acknowledger;
wherein the initiator and the first acknowledger initially communicate via the network.

2. The method of claim 1 further comprising the step of:
(g) correlating the at least one event detail to at least one profile attribute of the first acknowledger, wherein the first acknowledger is linked to a personal profile comprising at least one profile attribute.

3. The method of claim 1, wherein the plurality of users are members of a social network.

4. The method of claim 3, wherein the social network is a dating website.

5. The method of claim 1, further comprising the steps of:
(g) receiving, at the communications server, an alternate event detail from the first acknowledger, wherein the alternate event detail comprises a suggested deviation from the at least one event detail;
(h) transmitting, via the network, the alternate event detail to the initiator; and
(i) receiving, at the communications server, a response to the alternate event detail from the initiator.

6. The method of claim 1, further comprising the steps of:
(g) transmitting, via the network, the event initiation request to at least a first vendor;
(h) receiving, at the communications server, a response from the first vendor, wherein the response comprises an event offer; and
(i) transmitting, via the network, the event offer to the initiator.

7. The method of claim 1, further comprising the steps of:
(g) receiving, at the communications server, an event offer from the first vendor; and
(h) transmitting, via the network, the event offer to the plurality of users.

8. The method of claim 1, further comprising the steps of:
(g) receiving payment information from one or both the initiator and the first acknowledger, wherein the payment information is usable to process a payment for the at least first event detail.

9. The method of claim 8, further comprising the steps of:
(h) processing the payment utilizing the payment information.

10. The method of claim 1, wherein each of the at least one event detail is one of: an event location; an event time; an event activity; a payment responsibility; an event budget;
and an event offer.

11. The method of claim 1, wherein the at least one event detail is selected from a potential event details list presented to the initiator by the communications server.

12. The method of claim 11, wherein the potential event details list is based on initiator event preferences.

13. The method of claim 1, further comprising the step of:
(g) suggesting to the initiator and the first acknowledger, via a third party, the at least one event detail.

14. The method of claim 1, further comprising the step of:
(g) presenting the initiator and the first acknowledger with at least one event offer.

15. The method of claim 1, further comprising the steps of:
(g) receiving, at the communications server, a pre-payment for an event related to the event initiation request, the event provided by a vendor; and
(h) forwarding the pre-payment to the vendor.

16. The method of claim 1, further comprising the step of:
(g) authorizing transmittal step (b) based on a proximity between the initiator and the first acknowledger.

17. The method of claim 16, wherein the proximity is set by the first acknowledger.

18. The method of claim 1, further comprising the steps of:
(g) receiving, prior to step (a), a search request at the communications server indicating at last one parameter for the first acknowledger;
(h) presenting the initiator with information about at least one user, including information about the first acknowledger; and
(i) receiving a selection of the first acknowledger.

19. The method of claim 18, wherein each of the at least one parameters is chosen from the group consisting of: a gender; a username; a fitness level; an income level; an education level; physical characteristics; and a job type.

20. The method of claim 1, further comprising the steps of:
(g) receiving, prior to step (a), a search request at the communications server indicating at least one parameter for an event;
(h) presenting the initiator with information about a plurality of event, including an event related to the event initiation request of step (a); and
(i) receiving a selection of the event related to the event initiation request of step (a).

21. The method of claim 1, wherein the first acknowledger is a group representative.

22. One or more computer storage media having stored thereon multiple instructions that facilitate a personal, face-to-face meeting between an initiator and an acknowledger, when executed by one or more processors of a computing device, causing the one or more processors to:
(a) receive an event initiation request from the initiator, wherein the event initiation request comprises at least one event detail;
(b) transmit the event initiation request to the first acknowledger;
(c) receive at least one response to the event initiation request from the first acknowledger;
(d) transmit the at least one response to the initiator;
(e) coordinate at least one event detail related to the event initiation request; and
(f) coordinate communication between the initiator and the first acknowledger.

23. One or more computer storage media as recited in claim 22, wherein the one or more processors are further caused to:
(g) correlate the at least one event detail to at least one profile attribute of the first acknowledger, wherein the first acknowledger is linked to a personal profile comprising at least one profile attribute.

24. One or more computer storage media as recited in claim 22, wherein the one or more processors are further caused to:
(g) receive an alternate event detail from the first acknowledger, wherein the alternate event detail comprises a suggested deviation from the at least one event detail;
(h) transmit the alternate event detail to the initiator; and
(i) receive a response to the alternate event detail from the initiator.

25. One or more computer storage media as recited in claim 22, wherein the one or more processors are further caused to:
(g) transmit the event initiation request to at least a first vendor;
(h) receive a response from the first vendor, wherein the response comprises an event offer; and
(i) transmit the event offer to the initiator.

26. One or more computer storage media as recited in claim 22, wherein the one or more processors are further caused to:
(g) receive an event offer from the first vendor; and
(h) transmit the event offer to the plurality of users.

27. One or more computer storage media as recited in claim 22, wherein the one or more processors are further caused to:
(g) receive payment information from one or both the initiator and the first acknowledger, wherein the payment information is usable to process a payment for the at least first event detail.

28. One or more computer storage media as recited in claim 22, wherein the one or more processors are further caused to:
(g) suggest to the initiator and the first acknowledger the at least one event detail.

29. One or more computer storage media as recited in claim 22, wherein the one or more processors are further caused to:
(g) present the initiator and the first acknowledger with a plurality of event offers.

30. One or more computer storage media as recited in claim 22, wherein the one or more processors are further caused to:
(g) receive a pre-payment for an event related to the event initiation request, the event provided by a vendor; and
(h) forward the pre-payment to the vendor.

31. One or more computer storage media as recited in claim 22, wherein the one or more processors are further caused to:
(g) authorize transmittal based on a proximity between the initiator and the first acknowledger.

32. One or more computer storage media as recited in claim 31, wherein the proximity is set by at least one of: the first acknowledger and the initiator.

33. One or more computer storage media as recited in claim 22, wherein the one or more processors are further caused to:
(g) receive a search request at the communications server indicating parameters for the first acknowledger;
(h) present the initiator with information about a plurality of users, including information about the first acknowledger; and
(i) receive a selection of the first acknowledger.

34. One or more computer storage media as recited in claim 22, wherein the one or more processors are further caused to:
(g) receive a search request at the communications server indicating parameters for an event;
(h) present the initiator with information about a plurality of event, including an event related to the event initiation request; and
(i) receive a selection of the event related to the event initiation request.

35. A system for a personal, face-to-face meeting between an initiator and an acknowledger, comprising:
(a) at least one web server capable of providing a graphical user interface, via a communications network, to a plurality of computing devices, the plurality of computing devices configured to communicate with the initiator and the acknowledger; and
(b) at least one application server, communicatively coupled to the at least one web server via the communications network, the at least one application server comprising:
(i) a social networking service capable of:
(a) receiving an event initiation request from the initiator, wherein the event initiation request comprises at least one event detail;
(b) transmitting the event initiation request to the first acknowledger;
(c) receiving at least one response to the event initiation request from the first acknowledger;
(d) transmitting the at least one response to the initiator; and
(f) coordinating communication between the initiator and the first acknowledger.

36. The system as recited in claim 35, wherein the social networking service is a dating website.

37. The system as recited in claim 35, wherein the at least one application server further comprises:
(ii) a vendor coordinating service capable of:
(a) transmitting the event initiation request to at least a first vendor;
(b) receiving a response from the first vendor, wherein the response comprises an event offer; and
(c) transmitting the event offer to the initiator.
